(19) United States
(12) Patent Application Publication
(10) Pub. No.: US 2025/0124398 A1
(43) Pub. Date: Apr. 17, 2025

(54) METHOD, DEVICE, EQUIPMENT, AND STORAGE MEDIUM FOR WATER TRANSPORTATION CONSOLIDATION

(71) Applicant: WUHAN UNIVERSITY OF TECHNOLOGY, WUHAN (CN)

(72) Inventor: HONGCHU YU, WUHAN (CN)

(21) Appl. No.: 18/750,199

(22) Filed: Jun. 21, 2024

(30) Foreign Application Priority Data
Oct. 17, 2023 (CN) 202311343072.1

(51) Int. Cl. G06Q 10/0835; G06Q 10/0631

(52) U.S. Cl. CPC G06Q 10/08355; G06Q 10/06311

(57) ABSTRACT

Disclosed is a method, device, equipment, and storage medium for water transportation consolidation. The method comprises obtaining shipping data from different shipping companies, classifying the shipping data based on preset information categories, and obtaining shipping route related data, ship related data, and cargo related data; constructing a shipping schedule related nine-intersection model based on the shipping route related data; determining a consolidation plan for shipping data based on the shipping schedule related nine-intersection model, the cargo related data, and the ship related data, and carrying out consolidation based on the consolidation plan. This disclosure can save the operating costs of shipping companies, improve their efficiency, improve the utilization of transportation resources, reduce the number of vessel voyages, improve safety, reduce fuel consumption and carbon emissions, and help promote sustainable development and green water logistics.

### FIELD OF THE DISCLOSURE

The disclosure relates to the technical field of water transportation, in particular to a method, device, equipment, and storage medium for water transportation consolidation.

### BACKGROUND

The transportation cost of large ships per unit of cargo is generally much lower than that of small ships. When the production locations of each batch of scattered goods are relatively concentrated in a production area, and the sales locations are also relatively concentrated in a sales area, and the distance between the production area and the sales area is relatively far, developing a reasonable plan to transport scattered goods from different origins can effectively improve economic benefits.

However, in existing technology, consolidation is carried out by consolidating goods on the same shipping company's route, and consolidation cannot be achieved between different shipping companies.

Therefore, there is an urgent need for a water transportation consolidation method, device, equipment, and storage medium to solve the cargo consolidation between different shipping enterprises.

### SUMMARY

The purpose of this disclosure is to provide a method, device, equipment, and storage medium for water transportation consolidation to solve the technical problem of inability to achieve cargo consolidation between different shipping enterprises in existing technologies.

In order to solve the above technical problems, this disclosure provides a method for water transportation consolidation, comprising:
obtaining shipping data from different shipping companies, classifying the shipping data based on preset information categories, and obtaining shipping route related data, ship related data, and cargo related data; wherein the shipping route related data comprises shipping company code, route code, route departure port, route stopping ports, route destination port, departure time at the departure port, arrival time at each route stopping port, and destination port arrival time; the ship related data comprises ship identification code, ship cargo type, and ship deadweight; the cargo related data comprises cargo type and cargo capacity;
constructing a shipping schedule related nine-intersection model based on the shipping route related data;
determining a consolidation plan for shipping data based on the shipping schedule related nine-intersection model, the cargo related data, and the ship related data, and carrying out consolidation based on the consolidation plan;
the shipping schedule related nine-intersection model comprises nine-intersection model of route and nine-intersection model of time;
the method that determining a consolidation plan for shipping data based on the shipping schedule related nine-intersection model, the cargo related data, and the ship related data, and carrying out consolidation based on the consolidation plan comprises:
determining whether there is a consolidated shipping segment between the first route and the second route based on the nine-intersection model of route;
when there is a consolidated shipping segment, determining whether the consolidated shipping segment meets the time condition based on the nine-intersection model of time;
when the consolidated shipping segment meets a time condition, determining whether there are overlapping goods in the consolidated shipping segment based on the cargo related data;
when there are overlapping goods in the consolidated shipping segment, determining whether the consolidated shipping segment meets the requirements for cargo logistics loading based on ship related data;
when the consolidated shipping segment meets requirements for cargo logistics loading, carrying out consolidation in the consolidated shipping segment;
the nine-intersection model of route R₉ (SLᵢⱼ, SL_{pq}) is:

$$\{ \begin{matrix}{Port}_{ij 1} ⋂ {Port}_{pq 1} & {Port}_{ij 1} ⋂ \partial {Port}_{pq} & {Port}_{ij 1} ⋂ {Port}_{pqn} \\ \partial {Port}_{ij} ⋂ {Port}_{pq 1} & \partial {Port}_{ij} ⋂ \partial {Port}_{pq} & \partial {Port}_{ij} ⋂ {Port}_{pqn} \\ {Port}_{ijn} ⋂ {Port}_{pq 1} & {Port}_{ijn} ⋂ \partial {Port}_{pq} & {Port}_{ijn} ⋂ {Port}_{pqn}\end{matrix} \}$$

where, Portᵢⱼ₁ represents the departure port of route SLij, ∂Portᵢⱼ represents the intermediate stopping port of route SLij, Portᵢⱼₙ represents the destination port of route SLij. Port_{pq1} represents the departure port of route SLpq, ∂Port_{pq} represents the stopping port of route SLpq, Port_{pqn} represents the destination port of the SLpq route;
the nine-intersection model of time R₉ (Tᵢⱼ, T_{pq}) is:

$${R}_{9} ( {T}_{ij} , {T}_{pq} ) = \{ \begin{matrix}{T}_{ij 1} ⋂ {T}_{pq 1} & {T}_{ij 1} ⋂ \partial {T}_{pq} & {T}_{ij 1} ⋂ {T}_{pqn} \\ \partial {T}_{ij} ⋂ {T}_{pq 1} & \partial {T}_{ij} ⋂ \partial {T}_{pq} & \partial {T}_{ij} ⋂ {T}_{pqn} \\ {T}_{ijn} ⋂ {T}_{pq 1} & {T}_{ijn} ⋂ \partial {T}_{pq} & {T}_{ijn} ⋂ {T}_{pqn}\end{matrix} \}$$

where, Tᵢⱼ₁ represents the department time of the operating fleet of route SLij, ∂Tᵢⱼ represents the stopping time at the intermediate port of the operating fleet of route SLij, Tᵢⱼₙ represents the final port stop time of the operating fleet of route SLij. T_{pq1} represents the departure time of the operating fleet of route SLpq, and ∂T_{pq} represents the stopping time of the operating fleet of route SLpq at the intermediate port, T_{pqn} represents the final port stop time of the operating fleet on route SLpq.

Compared with existing technologies, the beneficial effect of this disclosure is: by obtaining shipping data from different shipping companies and categorizing them based on preset information categories, shipping route related data, ship related data, and cargo related data are obtained to achieve mixed and unified processing of shipping data from different shipping companies. Then, constructing a shipping schedule related nine-intersection model, and determining the shipping data consolidation plan based on the shipping schedule related nine-intersection model, the cargo related data, and the ship related data. This achieves consolidation for different shipping companies, saves operating costs for shipping companies, and improves their efficiency. And through consolidated transportation, multiple shipping companies can share transportation vessels and other facilities, helping small shipping companies overcome the problem of insufficient transportation capacity, jointly bear logistics costs, avoid empty waste of freight facilities and containers, and improve resource utilization efficiency. Shipping companies can reduce the number of vessel trips and lower the risk of traffic accidents through consolidated transportation. Consolidated transportation can reduce the number of times trucks or ships operate, reduce fuel consumption and carbon emissions, and help promote sustainable development and green water logistics.

Furthermore, based on the shipping schedule related nine-intersection model, the topological relationship between routes can be determined. The advantage of this model is that it can analyze a single route and simultaneously analyze the time windows and topological relationships of multiple routes for multi-route consolidation, thereby improving the efficiency of consolidation for shipping companies. This not only saves transportation costs but also solves the problem of insufficient transportation capacity. The calculation method is simple and the computational complexity is small, which can improve the generation efficiency of consolidation plans.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a flowchart of an embodiment of the method for water transportation consolidation provided by this disclosure;

FIG. 2 is a flowchart of an embodiment of step S103 in FIG. 1;

FIG. 3 is a flowchart of an embodiment of step S201 in FIG. 2;

FIG. 4 is a flowchart of another embodiment of step S201 in FIG. 2;

FIG. 5 is a flowchart of an embodiment of step S202 in FIG. 2;

FIG. 6 is a flowchart of an embodiment of step S204 in FIG. 2;

FIG. 7 is a schematic diagram of the first embodiment provided by this disclosure;

FIG. 8 is a schematic diagram of the second embodiment provided by this disclosure;

FIG. 9 is a schematic diagram of the third embodiment provided by this disclosure;

FIG. 10 is a schematic diagram of the fourth embodiment provided by this disclosure;

FIG. 11 is a schematic diagram of the fifth embodiment provided by this disclosure;

FIG. 12 is a schematic diagram of the sixth embodiment provided by this disclosure;

FIG. 13 is a schematic diagram of the seventh embodiment provided by this disclosure;

FIG. 14 is a schematic diagram of the eighth embodiment provided by this disclosure;

FIG. 15 is a schematic diagram of the ninth embodiment provided by this disclosure;

FIG. 16 is a schematic diagram of the tenth embodiment provided by this disclosure;

FIG. 17 is a schematic diagram of the structure of an embodiment of the device for water transportation consolidation provided by this disclosure;

FIG. 18 is a schematic diagram of the structure of an embodiment of the equipment for water transportation consolidation provided by this disclosure.

### DETAILED DESCRIPTION OF PREFERRED EMBODIMENTS

The technical solutions in the embodiments of the application will be described clearly and completely in combination with the drawings in the embodiments of the application.

The following will provide a clear and complete description of the technical solution in this disclosure, in conjunction with the accompanying drawings. Obviously, the described embodiments are only a partial embodiment of this disclosure, not the entire embodiment. Based on the embodiments in this disclosure, all other embodiments obtained by those skilled in the art without creative labor fall within the scope of this disclosure protection.

It should be understood that the schematic drawings are not drawn to the actual scale. The flowchart used in this disclosure illustrates the operations implemented based on some embodiments of this disclosure. It should be understood that the operations in a flowchart can be implemented out of sequence, and steps without logical contextual relationships can be reversed or implemented simultaneously. In addition, technical personnel in this field can add one or more other operations to the flowchart under the guidance of this disclosure content, and can also remove one or more operations from the flowchart.

Some of the block diagrams shown in the attached diagram are functional entities and may not necessarily correspond to physically or logically independent entities. These functional entities can be implemented in software form, or in one or more hardware modules or integrated circuits, or in different networks and/or processor systems and/or microcontroller systems.

Referring to “embodiment” in this article means that specific features, structures, or features described in conjunction with the embodiment may be included in at least one embodiment of this disclosure. The phrase appearing in various positions in the specification does not necessarily refer to the same embodiment, nor is it an independent or alternative embodiment that is mutually exclusive with other embodiments. Technicians in this field explicitly and implicitly understand that the embodiments described in this article can be combined with other embodiments.

This disclosure provides a method, device, equipment, and storage medium for water transportation consolidation, which will be explained separately below.

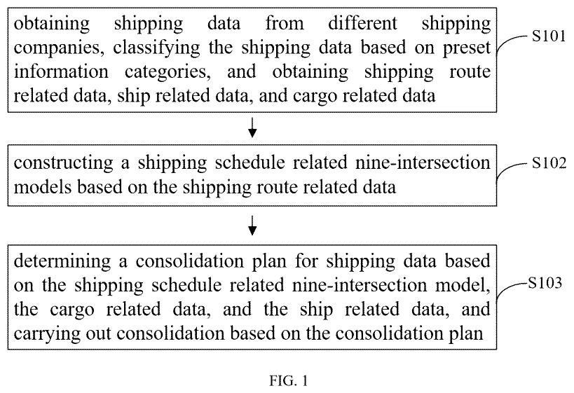

FIG. 1 is a flowchart of an embodiment of the method for water transportation consolidation provided by this disclosure, as shown in FIG. 1. The method for water transportation consolidation comprises:
S101, obtaining shipping data from different shipping companies, classifying the shipping data based on preset information categories, and obtaining shipping route related data, ship related data, and cargo related data; wherein the shipping route related data comprises shipping company code, route code, route departure port, route stopping ports, route destination port, departure time, arrival time at each route stopping port, and destination port arrival time; the ship related data comprises ship identification code, ship cargo type, and ship deadweight; the cargo related data comprises cargo type and cargo capacity;
S102, constructing a shipping schedule related nine-intersection models based on the shipping route related data;
S103, determining a consolidation plan for shipping data based on the shipping schedule related nine-intersection model, the cargo related data, and the ship related data, and carrying out consolidation based on the consolidation plan.

Compared to existing technology, in the embodiment of this disclosure, shipping data from different shipping companies are obtained and categorized based on preset information categories to obtain shipping route related data, ship related data, and cargo related data, thus achieving mixed and unified processing of shipping data from different shipping companies. Then, constructing a shipping schedule related nine-intersection model, and determining the shipping data consolidation plan based on the shipping schedule related nine-intersection model the cargo related data, and the ship related data. This achieves consolidation for different shipping companies, saves operating costs for shipping companies, and improves their efficiency. And through consolidated transportation, multiple shipping companies can share transportation vessels and other facilities, helping small shipping companies overcome the problem of insufficient transportation capacity, jointly bear logistics costs, avoid empty waste of freight facilities and containers, and improve resource utilization efficiency. Shipping companies can reduce the number of vessel trips and lower the risk of traffic accidents through consolidated transportation. Consolidated transportation can reduce the number of times trucks or ships operate, reduce fuel consumption and carbon emissions, and help promote sustainable development and green water logistics.

Furthermore, based on the shipping schedule related nine-intersection model, the topological relationship between routes can be determined. The advantage of this model is that it can analyze a single route and simultaneously analyze the time windows and topological relationships of multiple routes for multi-route consolidation, thereby improving the efficiency of consolidation for shipping companies. This not only saves transportation costs but also solves the problem of insufficient transportation capacity. The calculation method is simple and the computational complexity is small, which can improve the generation efficiency of consolidation plans.

In an embodiment of this disclosure, the way to obtain shipping data of different shipping companies in step S101 is to query the official websites, the annual reports, and the sustainability reports, etc., of the Mediterranean Shipping Company, the Maersk, the CMA CGM Group, the Orient Overseas Container Line Limited, the Ocean Network Express Pte. Ltd., the Hapag-Lloyd, the YangMing Marine Transport Corp., the EVERGREEN MARINE CORP., the WAN HAI LINES LTD., the Hyundai Merchant Marine, the Z Factor, the Pacific International Lines, the SITC International Holdings Co., Ltd., the KMTC e-Brochure, and collecting shipping data such as schedules, routes, fleets, voyages, and cargo throughput of the shipping companies.

Among them, the preset information categories in step S101 comprise flight category, vessel category, and cargo flow category.

Among them, the shipping route related data specifically refers to:
Compi:{SLij:{Shijk:(Portijk1, Tijk1),(Portijk2, Tijk2), . . . , (Portijkn, Tijkn)}},
where, Compi represents shipping company i, {SLij} represents the set of routes operated by shipping company i, SLij represents the j-th route operated by shipping company i, and {Shijk} represents the set of ships operated by shipping company i on the jth route, which is the fleets, Shijk represents the k-th vessel operated by shipping company i on the j-th route.

(Portijk1, Tijk1), (Portijk2, Tijk2), . . . , (Portijkn, Tijkn) represent the ports where the k-th vessel operated by shipping company i on the j-th route stops sequentially, where Portijk1 represents the port of departure, Tijk1 represents the department time, Portijkn represents the destination port, Tijkn represents the arrival time at the destination port, Portijk2 represents the stopping port, Tijk2 represents the arrival time at the stopping port.

Specifically, the ship identification code is the Maritime Mobile Service Identify (MMSI), the ship related data is:
Shijk:{MMSIijk,Deadweigthijk,CargoTypeijk},
where, MMSIijk represents the MMSI of the k-th vessel operated by shipping company i on the j-th route, Deadweigthijk represents the deadweight of the k-th vessel operated by shipping company i on the j-th route, CargoTypeijk represents the ship cargo type of the k-th vessel operated by shipping company i on the j-th route.

The cargo related data is:
Cargoᵢ:{Cargoᵢⱼ:(Cargoᵢⱼ₁,(Cargoᵢⱼ₂, . . . , Cargoᵢⱼₘ)}
   where, Cargoᵢ represents the cargo flow of shipping company i, Cargoᵢⱼ represents the cargo flow of shipping company i on route j, Cargoᵢⱼₘ represents the cargo flow of the m-th cargo type for shipping company i on route j.

In some embodiments of this disclosure, the shipping schedule related nine-intersection comprises nine-intersection model of route and nine-intersection model of time; The nine-intersection model of route comprises a cargo type nine-intersection model.

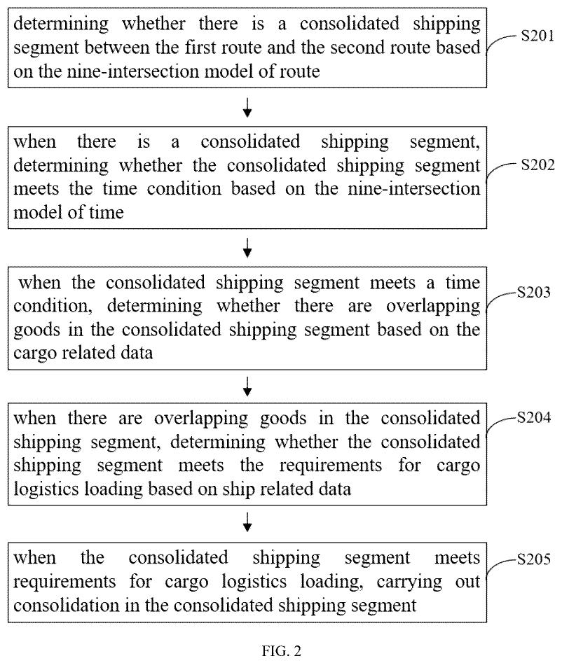

As shown in FIG. 2, step S103 comprises:
S201, determining whether there is a consolidated shipping segment between the first route and the second route based on the nine-intersection model of route;
S202, when there is a consolidated shipping segment, determining whether the consolidated shipping segment meets the time condition based on the nine-intersection model of time;
S203, when the consolidated shipping segment meets a time condition, determining whether there are overlapping goods in the consolidated shipping segment based on the cargo related data;
S204, when there are overlapping goods in the consolidated shipping segment, determining whether the consolidated shipping segment meets the requirements for cargo logistics loading based on ship related data;
S205, when the consolidated shipping segment meets requirements for cargo logistics loading, carrying out consolidation in the consolidated shipping segment.

In this embodiment of this disclosure, after determining whether there is a consolidated shipping segment between the first route and second route through the nine-intersection model of route, consolidation is not directly carried out in that consolidated shipping segment. Instead, time conditions, overlapping goods, and cargo flow loading requirements are considered. Through multi-dimensional considerations, the rationality and accuracy of consolidation in consolidated shipping segments were improved, thereby improving the operational efficiency of shipping enterprises.

In this embodiment of this disclosure, the nine-intersection model of route R₉ (SLᵢⱼ, SL_{pq}) is:

$$\{ \begin{matrix}{Port}_{ij 1} ⋂ {Port}_{pq 1} & {Port}_{ij 1} ⋂ \partial {Port}_{pq} & {Port}_{ij 1} ⋂ {Port}_{pqn} \\ \partial {Port}_{ij} ⋂ {Port}_{pq 1} & \partial {Port}_{ij} ⋂ \partial {Port}_{pq} & \partial {Port}_{ij} ⋂ {Port}_{pqn} \\ {Port}_{ijn} ⋂ {Port}_{pq 1} & {Port}_{ijn} ⋂ \partial {Port}_{pq} & {Port}_{ijn} ⋂ {Port}_{pqn}\end{matrix} \}$$

where, Portᵢⱼ₁ represents the departure port of route SLij, ∂Portᵢⱼ represents the intermediate stopping port of route SLij, Portᵢⱼₙ represents the destination port of route SLij. Port_{pq1} represents the departure port of route SLpq, ∂Port_{pq} represents the stopping port of route SLpq, Port_{pqn} represents the destination port of the SLpq route.

In this embodiment of this disclosure, the nine-intersection model of time R₉ (Tᵢⱼ, T_{pq}) is:

$${R}_{9} ( {T}_{ij} , {T}_{pq} ) = \{ \begin{matrix}{T}_{ij 1} ⋂ {T}_{pq 1} & {T}_{iij 1} ⋂ \partial {T}_{pq} & {T}_{ij 1} ⋂ {T}_{pqn} \\ \partial {T}_{ij} ⋂ {T}_{pq 1} & \partial {T}_{ij} ⋂ \partial {T}_{pq} & \partial {T}_{ij} ⋂ {T}_{pqn} \\ {T}_{ijn} ⋂ {T}_{pq 1} & {T}_{ijn} ⋂ \partial {T}_{pq} & {T}_{ijn} ⋂ {T}_{pqn}\end{matrix} \}$$

where, Tᵢⱼ₁ represents the department time of the operating fleet of route SLᵢⱼ, ∂Tᵢⱼ represents the stopping time at the intermediate port of the operating fleet of route SLij, Tᵢⱼₙ represents the final port stop time of the operating fleet of route SLij. T_{pq1} represents the departure time of the operating fleet of route SLpq, and ∂T_{pq} represents the stopping time of the operating fleet of route SLpq at the intermediate port, T_{pqn} represents the final port stop time of the operating fleet on route SLpq.

In an embodiment of this disclosure, the specific way to determine whether there is overlapping cargo in the consolidated shipping segment in step S203 is to determine whether there is intersection in the cargo logistics of the consolidated shipping segment, which is defined as:

$$R ( {Cargo}_{ij} , {Cargo}_{pq} ) = {Cargo}_{ij} ∩ {Cargo}_{pq} = ( {Cargo}_{ij 1} , {Cargo}_{ij 2} , … , {Cargo}_{ijm} ) ∩ ( {Cargo}_{pq 1} , {Cargo}_{pq 2} , … , {Cargo}_{pqm} )$$

When R (Cargoᵢⱼ, Cargo_{pq}) is not 0, it is considered that there are goods that can be consolidated on the SLij and SLpq routes, that is, there are overlapping goods.

In some embodiments of this disclosure, the first route comprises a first departure port and a first destination port, and the second route comprises a second departure port and a second destination port; That is, neither the first route nor the second route has a stopping port.

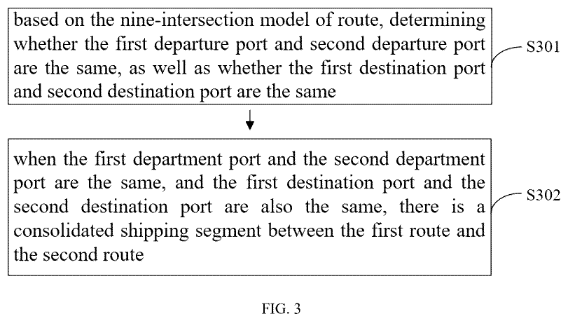

As shown in FIG. 3, step S201 is as follows:
S301, based on the nine-intersection model of route, determining whether the first departure port and second departure port are the same, as well as whether the first destination port and second destination port are the same;
S302, when the first department port and the second department port are the same, and the first destination port and the second destination port are also the same, there is a consolidated shipping segment between the first route and the second route.

That is, when Portᵢⱼ₁∩Port_{pq1}=1 and Portᵢⱼₙ∩Port_{pqn}=1 in the nine-intersection model of route, the destination port and the destination port of route SLij and route SLpq intersect, it is considered that SLij and SLpq have a consolidated shipping segment, the consolidated shipping segment is: from the first department port to the first destination port, or from the second department port to the second destination port.

In some other embodiments of this disclosure, the first route comprises the first departure port, the first destination port, and at least one first stopping port, the second route comprises the second departure port, the second destination port, and at least one second stopping port.

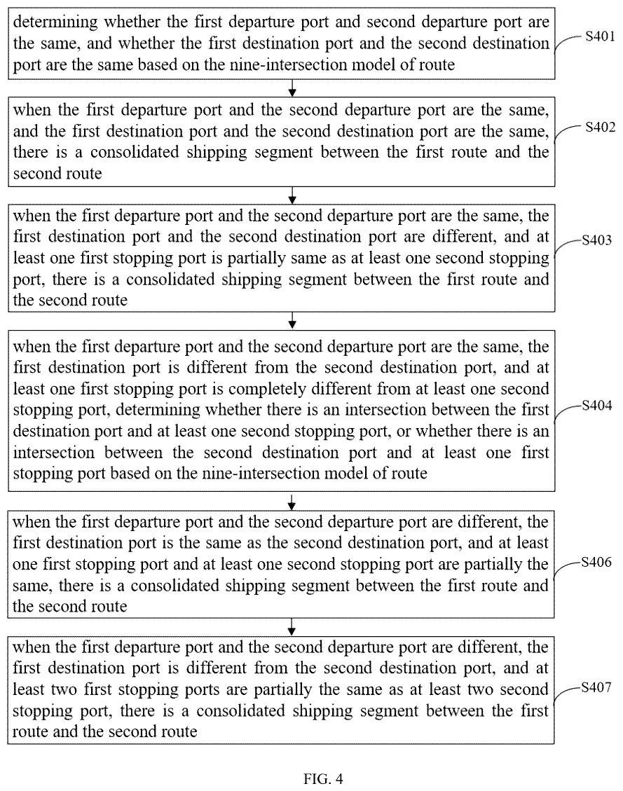

As shown in FIG. 4, step S201 also comprises:
S401, determining whether the first departure port and second departure port are the same, and whether the first destination port and the second destination port are the same based on the nine-intersection model of route;
S402, when the first departure port and the second departure port are the same, and the first destination port and the second destination port are the same, there is a consolidated shipping segment between the first route and the second route;
S403, when the first departure port and the second departure port are the same, the first destination port and the second destination port are different, and at least one first stopping port is partially same as at least one second stopping port, there is a consolidated shipping segment between the first route and the second route;
S404, when the first departure port and the second departure port are the same, the first destination port is different from the second destination port, and at least one first stopping port is completely different from at least one second stopping port, determining whether there is an intersection between the first destination port and at least one second stopping port, or whether there is an intersection between the second destination port and at least one first stopping port based on the nine-intersection model of route;
S405, when there is an intersection between the first destination port and at least one second stopping port, or when there is an intersection between the second destination port and at least one first stopping port, there is a consolidated shipping segment between the first route and the second route;
S406, when the first departure port and the second departure port are different, the first destination port is the same as the second destination port, and at least one first stopping port and at least one second stopping port are partially the same, there is a consolidated shipping segment between the first route and the second route;
S407, when the first departure port and the second departure port are different, the first destination port is different from the second destination port, and at least two first stopping ports are partially the same as at least two second stopping port, there is a consolidated shipping segment between the first route and the second route.

It should be understood that in step S402, the first departure port and the second departure port are the same, and the first destination port is the same as the second destination port, which comprises three situations, specifically:

The first situation is that the first departure port and the second departure port are the same, the first destination port is the same as the second destination port, and each first stopping port is exactly the same as each second stopping port, that is:

$${Port}_{ij 1} ⋂ {Port}_{pq 1} = 1 and {Port}_{ijn} ⋂ {Port}_{pqn} = 1 , \\ and , \\ \partial {Port}_{ij} \neq 0 and \partial {Port}_{pq} \neq 0 and \partial {Port}_{ij} = \partial {Port}_{pq}$$

In this situation, the consolidated shipping segment is the entire segment of the first route or the entire segment of the second route. That is, the route can be interrupted and only partial segments can be consolidated, for example: consolidation between the departure port and the stopping port, or consolidation between at least two stopping ports, or consolidation between intermediate and destination ports.

The second situation is that the first departure port and the second departure port are the same, the first destination port is the same as the second destination port, but the first stopping port and second stopping port are completely different, that is:

$${Port}_{ij 1} ∩ {Port}_{pq 1} = 1 and {Port}_{ijn} {∩Port}_{pqn} = 1 , \\ and , \\ \partial {Port}_{ij} \neq 0 and \partial {Port}_{pq} \neq 0 and \partial {Port}_{ij} ∩ \partial {Port}_{pq} = 0$$

In this situation, the consolidated shipping segment is only used for consolidation at the port of departure and destination.

The third situation is that the first departure port and the second departure port are the same, the first destination port is the same as the second destination port, and the first stopping port and second stopping port are partially the same, that is:

$${Port}_{ij 1} ⋂ {Port}_{pq 1} = 1 and {Port}_{ijn} {∩Port}_{pqn} = 1 , \\ and , \partial {Port}_{ij} \neq 0 and \partial {Port}_{pq} \neq 0 and \partial {Port}_{ij} ∩ \partial {Port}_{pq} = 1$$

In this situation, for the same stopping port, consolidation can be carried out between the departure port and the stopping port, as well as between the stopping port and the destination port.

Where, in step S403, the first departure port and second departure port are the same, the first destination port is different from the second destination port. At least one first stopping port and at least one second stopping port are partially the same, which comprises two situations, specifically:

The first situation is that the first departure port and the second departure port are the same, the first destination port is different from the second destination port, at least one first stopping port is partially the same as at least one second stopping port, and there is an intersection between the first destination port and at least one second stopping port, or there is an intersection between the second destination port and at least one first stopping port, i.e.:

$${Port}_{ij 1} {∩Port}_{pq 1} = 1 and {Port}_{ijn} {∩Port}_{pqn} \neq 1 , \\ and , \partial {Port}_{ij} \neq 0 and \partial {Port}_{pq} \neq 0 and \partial {Port}_{ij} ∩ \partial {Port}_{pq} = 1 , \\ and , {Port}_{ijn} ∩ \partial {Port}_{pq} = 1 or {Port}_{pqn} ∩ \partial {Port}_{ij} = 1$$

In this situation, consolidation can be carried out between the departure port and the stopping port, as well as between the departure port and the destination port of the two shipping routes.

The second situation is that the first departure port and the second departure port are the same, the first destination port is different from the second destination port, at least one first stopping port is partially the same as at least one second stopping port, and the first destination port does not intersect with at least one second stop port, and there is no intersection between the second destination port and at least one first stop port, i.e.:

$${Port}_{ij 1} {∩Port}_{pq 1} = 1 and {Port}_{ijn} {∩Port}_{pqn} \neq 1 , \\ and , \\ \partial {Port}_{ij} \neq 0 and \partial {Port}_{pq} \neq 0 and \partial {Port}_{ij} ∩ \partial {Port}_{pq} = 1$$

In this situation, it is possible to combine the departure port and stopping ports of the two routes for transportation.

Among them, step S405 can be described as:

$${Port}_{ij 1} {∩Port}_{pq 1} = 1 and {Port}_{ijn} {∩Port}_{pqn} \neq 1 , \\ and , \\ \partial {Port}_{ij} \neq 0 and \partial {Port}_{pq} \neq 0 and \partial {Port}_{ij} ∩ \partial {Port}_{pq} \neq 1 , \\ and , \\ {Port}_{ijn} ∩ \partial {Port}_{pq} = 1 or {Port}_{pqn} ∩ \partial {Port}_{ij} = 1 ,$$

Then, consolidation can be carried out between the departure ports and the destination ports that intersect of the two routes.

Among them, step S406 can be described as:

$${Port}_{ij 1} {∩Port}_{pq 1} \neq 1 and {Port}_{ijn} {∩Port}_{pqn} = 1 , \\ and , \\ \partial {Port}_{ij} \neq 0 and \partial {Port}_{pq} \neq 0 and \partial {Port}_{ij} ∩ \partial {Port}_{pq} = 1 , \\ and , {Port}_{ijn} ∩ \partial {Port}_{pq} \neq 1 or {Port}_{pqn} ∩ \partial {Port}_{ij} \neq 1 ,$$

Then, partial consolidation will be carried out between the same stopping port and destination port in both routes.

Among them, the first departure port and second departure port in step S407 are different, the first destination port is different from the second destination port, at least two first stopping ports and at least two second stopping ports are partially the same, which comprises two situations, specifically: The first situation is that the destination port of one route does not intersect with the stopping ports of another route, that is:

$${Port}_{ij 1} {∩Port}_{pq 1} \neq 1 and {Port}_{ijn} {∩Port}_{pqn} = 1 , \\ and , \\ \partial {Port}_{ij} \neq 0 and \partial {Port}_{pq} \neq 0 and \partial {Port}_{ij} ∩ \partial {Port}_{pq} = 1 , \\ and , {Port}_{ijn} ∩ \partial {Port}_{pq} \neq 1 or {Port}_{pqn} ∩ \partial {Port}_{ij} \neq 1 ,$$

In this situation, partial consolidation can be carried out between the same stopping ports.

The second situation is that the destination port of one route intersects with the stopping port of another route, that is:

$${Port}_{ij 1} {∩Port}_{pq 1} \neq 1 and {Port}_{ijn} {∩Port}_{pqn} = 1 , \\ and , \\ \partial {Port}_{ij} \neq 0 and \partial {Port}_{pq} \neq 0 and \partial {Port}_{ij} ∩ \partial {Port}_{pq} = 1 , \\ and , {Port}_{ijn} ∩ \partial {Port}_{pq} \neq 1 or {Port}_{pqn} ∩ \partial {Port}_{ij} \neq 1 ,$$

In this situation, consolidation can be carried out between partially identical stopping ports, as well as between partially identical stopping ports and destination ports.

In summary, in the above ten situations, both routes have a consolidated shipping segment.

In some embodiments of this disclosure, the consolidated shipping segment comprises a departure port for consolidated shipment and an arrival port for consolidated shipment;

As shown in FIG. 5, step S202 comprises:
S501, obtaining the first departure time of the first route at the departure port for consolidated shipment and the first arrival time of the first route at the arrival port for consolidated shipment;
S502, obtaining the second departure time of the second route at the departure port for consolidated shipment and the second arrival time of the second route at the arrival port for consolidated shipment;
S503, based on the nine-intersection model of time, determining whether there is a time intersection between the first departure time and the second departure time, as well as whether there is a time intersection between the first arrival time and the second arrival time;
S504, when there is a time intersection between the first departure time and the second departure time, and there is a time intersection between the first arrival time and the second arrival time, the consolidated shipping segment satisfies the time condition;
S505, when there is no time intersection between the first departure time and the second departure time, and/or when there is no time intersection between the first arrival time and the second arrival time, determining whether the time difference between the first departure time and the second departure time and the time difference between the first arrival time and the second arrival time are both less than a preset time difference;
S506, when the time difference between the first departure time and the second departure time and the time difference between the first arrival time and second arrival time are both less than the preset time difference, the consolidated shipping segment satisfies the time condition.

It should be noted that the preset time difference should meet the time agreed upon in the goods transportation contract.

The embodiments of this disclosure can avoid technical problems caused by forced consolidation, which may result in the inability to deliver goods according to the agreed time in the contract, by setting time conditions. While carrying out consolidation, it ensures that the transportation time meets the agreed time in the contract.

In some embodiments of this disclosure, the consolidated shipping segment comprises a first vessel in the first route and a second vessel in the second route;

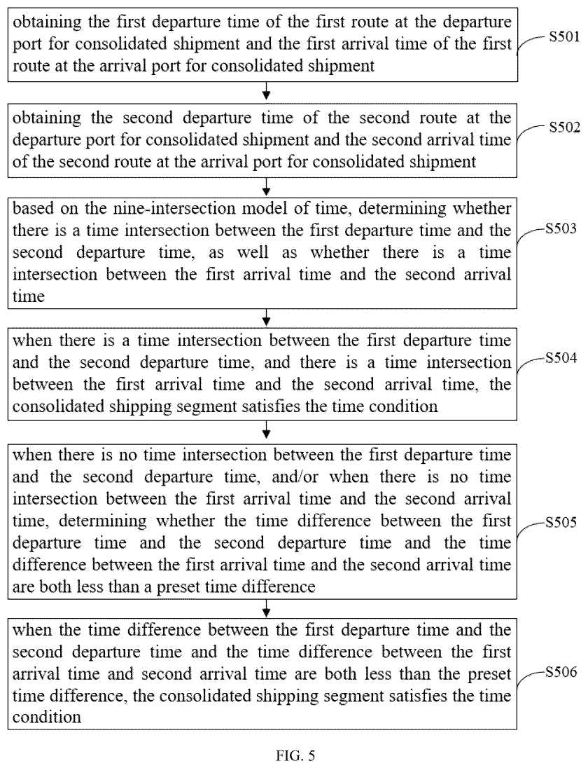

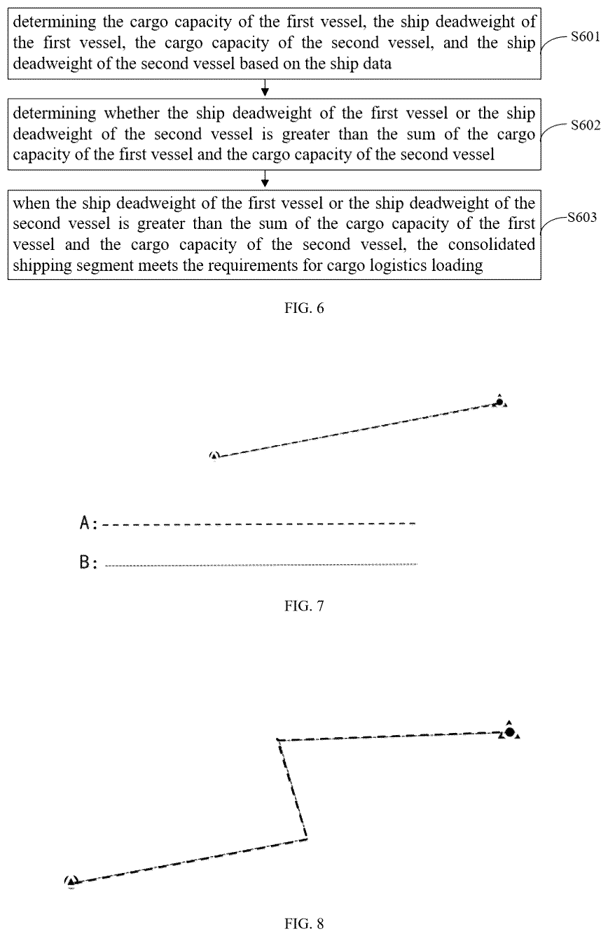

As shown in FIG. 6, step S204 comprises:
S601, determining the cargo capacity of the first vessel, the ship deadweight of the first vessel, the cargo capacity of the second vessel, and the ship deadweight of the second vessel based on the ship related data;
S602, determining whether the ship deadweight of the first vessel or the ship deadweight of the second vessel is greater than the sum of the cargo capacity of the first vessel and the cargo capacity of the second vessel;
S603, when the ship deadweight of the first vessel or the ship deadweight of the second vessel is greater than the sum of the cargo capacity of the first vessel and the cargo capacity of the second vessel, the consolidated shipping segment meets the requirements for cargo logistics loading.

By following steps S601˜603, it is ensured that fewer vessels can meet the loading requirements of goods, avoiding ineffective consolidation and improving the reliability and accuracy of consolidation.

In a specific embodiment of this disclosure, as shown in FIG. 7,
Route A: a—>b, departure time: Jul. 29, 2023-Aug. 1, 2023, arrival time: August 14, cargo type: dry bulk cargo, cargo volume: 60000 tons;
Route B: a—>b, departure time: Jul. 28, 2023-Aug. 1, 2023, arrival time: August 14, cargo type: dry bulk cargo, cargo volume: 90000 tons;

When the maximum available ship capacity at Port a is 120000 tons, consolidated transportation cannot be carried out;

When the maximum available ship capacity at Port a is 16000 tons, consolidated transportation can be carried out.

In a specific embodiment of this disclosure, as shown in FIG. 8,
Route A: a-c-b-d, departure time: Jul. 29, 2023-Aug. 1, 2023, arrival time at Port c: August 14, arrival time at Port b: August 21, final stop time: September 24, cargo type: dry bulk cargo, cargo volume: 60000 tons;
Route B: a-c-b-d, departure time: Jul. 28, 2023-Aug. 1, 2023, arrival time at Port c: August 14, arrival time at Port b: August 21, final stop time: September 24, cargo type: dry bulk cargo, cargo volume: 90000 tons;

When the maximum available ship capacity at Port a is 120000 tons, consolidated transportation cannot be carried out;

When the maximum available ship capacity at Port a is 16000 tons, the capacity is sufficient and the arrival time at each port is close, so consolidated transportation can be carried out.

In a specific embodiment of this disclosure, as shown in FIG. 9,
Route A: a-b-d, departure time: Jul. 29, 2023-Aug. 1, 2023, final stop time: September 24, cargo type: dry bulk cargo, cargo volume: 60000 tons;
Route B: a-c-d, departure time: Jul. 28, 2023-Aug. 1, 2023, final stop time: September 24, cargo type: dry bulk cargo, cargo volume: 90000 tons;

When the maximum available ship capacity at Port a is 120000 tons, consolidated transportation cannot be carried out;

When the maximum available ship capacity at Port a is 16000 tons, consolidated transportation can be carried out.

In a specific embodiment of this disclosure, as shown in FIG. 10,
Route A: a-b-d, departure time: Jul. 29, 2023-Aug. 1, 2023, arrival time at Port b: August 21, final stop time: September 24, cargo type: dry bulk cargo, cargo volume: 60000 tons;
Route B: a-c-b-d, departure time: Jul. 28, 2023-Aug. 1, 2023, arrival time at Port c: August 14, arrival time at Port b: August 21, final stop time: September 24, cargo type: dry bulk cargo, cargo volume: 90000 tons;

When the maximum available ship capacity at Port a is 120000 tons, consolidated transportation cannot be carried out;

When the maximum available ship capacity at Port a is 16000 tons, the capacity is sufficient and the arrival time at each port is close, so consolidated transportation can be carried out.

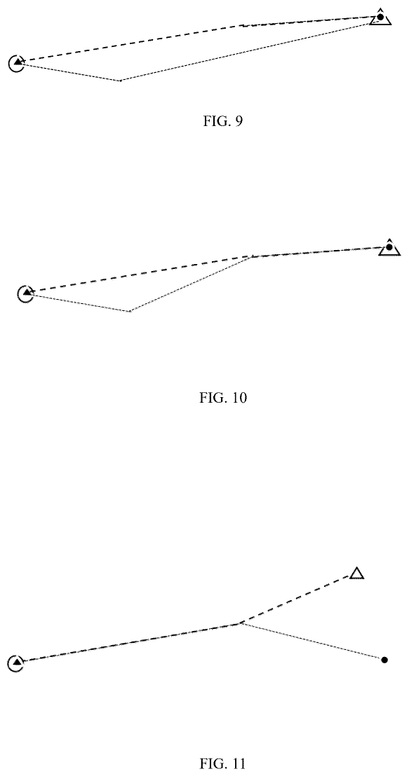

In a specific embodiment of this disclosure, as shown in FIG. 11,
Route A: a-b-c, departure time: Jul. 29, 2023-Aug. 1, 2023, arrival time at Port b: August 14, cargo type: dry bulk cargo, cargo volume: 60000 tons;
Route B: a-b-d, departure time: Jul. 28, 2023-Aug. 1, 2023, arrival time at Port b: August 14, cargo type: dry bulk cargo, cargo volume: 90000 tons;

When the maximum available ship capacity at Port a is 120000 tons, consolidated transportation cannot be carried out;

When the maximum available ship capacity at Port a is 16000 tons, the capacity is sufficient and the arrival time at the intermediate ports is close, so consolidated transportation can be carried out.

In a specific embodiment of this disclosure, as shown in FIG. 12,
Route A: a-c-e-f, departure time: Jul. 29, 2023-Aug. 1, 2023, arrival time at Port c: August 21, arrival time at Port e: September 1, final stop time: September 10,cargo type: dry bulk cargo, cargo volume: 60000 tons.
Route B: a-b-c-e, departure time: Jul. 28, 2023-Aug. 1, 2023, arrival time at Port b: August 14, arrival time at Port c: August 21, final stop time, arrival time at Port e: September 1, type of cargo: dry bulk cargo, cargo volume: 90000 tons.

When the maximum available ship capacity at Port a is 120000 tons, consolidated transportation cannot be carried out;

When the maximum available ship capacity at Port a is 16000 tons, the capacity is sufficient and the arrival time at each port is close, so consolidated transportation can be carried out.

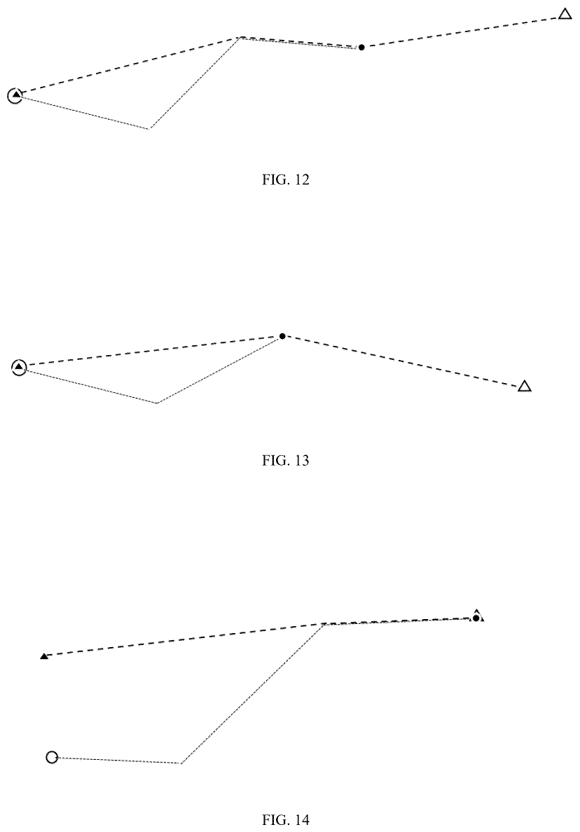

In a specific embodiment of this disclosure, as shown in FIG. 13,
Route A: a-c-d, departure time: Jul. 29, 2023-Aug. 1, 2023, arrival time at Port c: August 14, final stop time: September 24, cargo type: dry bulk cargo, cargo volume: 60000 tons;
Route B: a-b-c, departure time: Jul. 28, 2023-Aug. 1, 2023, arrival time at Port b: August 14, final stop time at Port c: August 21, cargo type: dry bulk cargo, cargo volume: 90000 tons;

Due to the significant time difference in arrival at Port c, consolidated shipping is not possible.

In a specific embodiment of this disclosure, as shown in FIG. 14,
Route A: a-b-d, departure time: Jul. 29, 2023-Aug. 1, 2023, arrival time at Port b: August 21, final stop time: September 2, cargo type: dry bulk cargo, cargo volume: 60000 tons;
Route B: e-c-b-d, departure time: Jul. 28, 2023-Aug. 1, 2023, arrival time at Port c: August 14, arrival time at Port b: August 21, final stop time: September 2. Type of cargo: dry bulk cargo, cargo volume: 90000 tons.

When the maximum available ship capacity at Port b is 120000 tons, consolidated transportation cannot be carried out;

When the maximum available ship capacity at Port b is 16000 tons, the capacity is sufficient and the arrival time at each port is close, so consolidated transportation can be carried out.

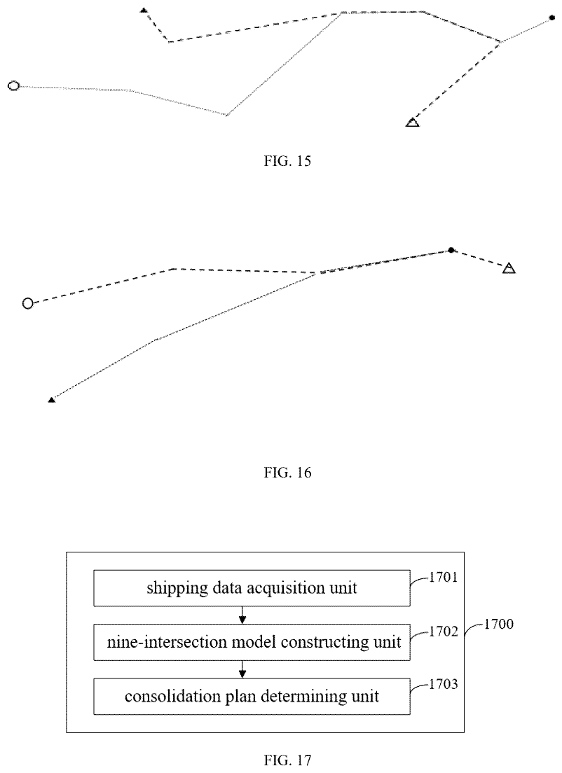

In a specific embodiment of this disclosure, as shown in FIG. 15,
Route A: a-b-c-d-e-f, departure time: Jul. 29, 2023-Aug. 1, 2023, arrival time at Port c: August 14, arrival time at Port d: August 21, arrival time at Port e: September 11, final stop time: September 24, cargo type: dry bulk cargo, cargo volume: 60000 tons;
Route B: k-h-i-c-d-e-j, departure time: Jul. 28, 2023-Aug. 1, 2023, arrival time at Port c: August 14, arrival time at Port d: August 21, arrival time at Port e: September 11, final stop time: September 17, type of cargo: dry bulk cargo, cargo volume: 90000 tons.

When the maximum available ship capacity at Port c is 120000 tons, consolidated transportation cannot be carried out;

When the maximum available ship capacity at Port c is 16000 tons, the capacity is sufficient and the arrival time at each port is close, so consolidation can be carried out on the c-d-e route.

In some embodiments of this disclosure, as shown in FIG. 16,
Route A: a-b-c-d-e, departure time: Jul. 29, 2023-Aug. 1, 2023, arrival time at Port b: August 14, arrival time at Port c: August 21, arrival time at Port d: September 11, final stop time: September 24, cargo type: dry bulk cargo, cargo volume: 60000 tons;
Route B: f-g-c-d, departure time: Jul. 31, 2023-Aug. 3, 2023, arrival time at Port c: August 14, final stop time: August 21, cargo type: dry bulk cargo, cargo volume: 90000 tons.

When the maximum available ship capacity at Port c is 120000 tons, consolidated transportation cannot be carried out;

When the maximum available ship capacity at Port c is 16000 tons, the capacity is sufficient and the arrival time at each port is close, so consolidated transportation can be carried out on the c-d route.

In order to better implement the water transportation consolidation method in this disclosure, based on the water transportation consolidation method, correspondingly, this disclosure also provides a device for water transportation consolidation, as shown in FIG. 17. The device for water transportation consolidation 1700 comprises:
a shipping data acquisition unit 1701, which is used to obtain shipping data from different shipping companies, classify the shipping data based on preset information categories, and obtain shipping route related data, ship related data, and cargo related data; wherein the shipping route related data comprises shipping company code, route code, route departure port, route stopping port, route destination port, departure time, arrival time at route stopping port, and destination port arrival time; the ship related data comprises ship identification code, ship cargo type, and ship deadweight; the cargo related data comprises cargo type and cargo capacity;
a nine-intersection model constructing unit 1702, which is used to construct a shipping schedule related nine-intersection model based on the shipping route related data;
a consolidation plan determining unit 1703, which is used to determine a consolidation plan for shipping data based on the shipping schedule related nine-intersection model, the cargo related data, and the ship related data, and carry out consolidation based on the consolidation plan.

The device for water transportation consolidation 1700 provided in the above embodiment can achieve the technical solution described in the above water transportation consolidation method. The specific implementation principles of the above modules or units can be found in the corresponding content of the above water transportation consolidation method embodiments, and will not be repeated here.

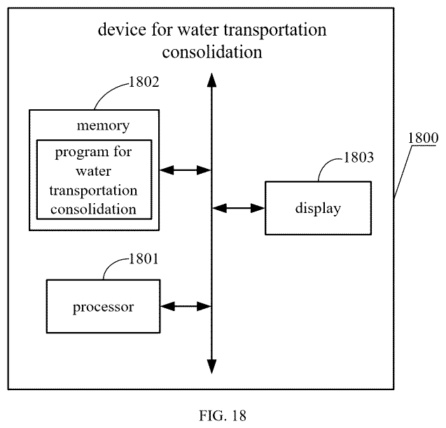

As shown in FIG. 18, This disclosure also provides a corresponding equipment for water transportation consolidation 1800. The equipment for water transportation and consolidation 1800 comprises a processor 1801, a memory 1802, and a display 1803. FIG. 18 only shows some components of the equipment for water transportation and consolidation 1800, but it should be understood that it is not required to implement all the shown components, and more or fewer components can be implemented as an alternative.

The processor 1801 may be a Central Processing Unit (CPU) in some embodiments, a microprocessor or other data processing chip used to run program code stored in the memory 1802 or process data, such as the method for water transportation and consolidation in this disclosure.

In some embodiments, the processor 1801 may be a single server or a group of servers. The server group can be centralized or distributed. In some embodiments, the processor 1801 may be local or remote. In some embodiments, the processor 1801 may be implemented on a cloud platform. In one embodiment, the cloud platform may comprise private cloud, public cloud, hybrid cloud, community cloud, distributed cloud, inter internal, multi cloud, or any combination of the above.

The memory 1802, in some embodiments, may be an internal storage unit of the device for water transportation consolidation 1800, such as a hard disk or memory of the device for water transportation consolidation 1800. The memory 1802 can also be an external storage device of the device for water transportation consolidation 1800 in other embodiments, such as a plug-in hard disk or a Smart Media Card (SMC), a Secure Digital card, a SD card, a Flash card, etc. equipped on the device for water transportation consolidation 1800,

Furthermore, the memory 1802 may also comprises both internal storage units of the device for waterway transportation consolidation 1800 and external storage devices. The memory 1802 is used to store application software and various data for the installation of the equipment for water transportation and consolidation 1800.

In some embodiments, the display 1803 can be an LED display, an LCD display, a touch LCD display, and an OLED (Organic Light Emitting Diode) touchscreen. The display 1803 is used to display information on the equipment for water transportation and consolidation 1800, as well as to display a visual user interface. The components 1801-1803 of the equipment for water transportation and consolidation 1800 communicate with each other through the system bus.

In some embodiments of this disclosure, when the processor 1801 executes the water transportation and consolidation program in the memory 1802, the following steps can be achieved:
obtaining shipping data from different shipping companies, classifying the shipping data based on preset information categories, and obtaining shipping route related data, ship related data, and cargo related data; wherein the shipping route related data comprises shipping company code, route code, route departure port, route stopping port, route destination port, departure time, arrival time at route stopping port, and destination port arrival time; the ship related data comprises ship identification code, ship cargo type, and ship deadweight; the cargo related data comprises cargo type and cargo capacity;
constructing a shipping schedule related nine-intersection model based on the shipping route related data;
determining a consolidation plan for shipping data based on the shipping schedule related nine-intersection model, the cargo related data, and the ship related data, and carrying out consolidation based on the consolidation plan.

It should be understood that when the processor 1801 executes the water transportation and consolidation program in the memory 1802, in addition to the above functions, it can also implement other functions, as described in the corresponding method embodiments earlier.

Furthermore, the embodiments of this disclosure do not impose specific restrictions on the types of the equipment for water transportation consolidation 1800 mentioned. The equipment for water transportation consolidation 1800 can be a mobile phone, tablet, or personal digital assistant (PDA), portable equipment such as wearable devices and laptops. Embodiments of portable waterway transportation consolidation equipment include but are not limited to carrying IOS Portable water transportation and consolidation equipment for Android, Microsoft, or other operating systems. The above-mentioned portable waterway transportation and consolidation equipment can also be other portable waterway transportation and consolidation equipment, such as a laptop with a touch sensitive surface (such as a touch panel). It should also be understood that in some other embodiments of this disclosure, the device for water transportation consolidation 1800 may not be a portable device, but a desktop computer with a touch sensitive surface (such as a touch panel).

Correspondingly, the present embodiment also provides a computer-readable storage medium, which is used to store programs or instructions that can be read by a computer. When the program or instruction is executed by a processor, it can realize the steps or functions of the waterway transportation and consolidation methods provided in the above method embodiments.

Technicians in this field can understand that all or part of the process of implementing the above embodiments can be completed by instructing relevant hardware (such as processors, controllers, etc.) through computer programs, which can be stored in computer-readable storage media. Among them, computer-readable storage media include disks, optical discs, read-only storage memory, or random storage memory.

The above provides a detailed introduction to a waterway transportation consolidation method, device, equipment, and storage medium provided by this disclosure. This article applies specific examples to explain the principle and implementation of this disclosure. The above examples are only used to help understand the method and core idea of this disclosure; Meanwhile, for technical personnel in this field, there may be changes in specific implementation methods and application scope based on the concept of this disclosure. In summary, the content of this manual should not be understood as a limitation on this disclosure.

It is to be understood, however, that even though numerous characteristics and advantages of this disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method for water transportation consolidation, comprising:
obtaining shipping data from different shipping companies, classifying the shipping data based on preset information categories, and obtaining shipping route related data, ship related data, and cargo related data; wherein the shipping route related data comprises shipping company code, route code, route departure port, route stopping ports, route destination port, departure time at departure port, arrival time at route stopping ports, and destination port arrival time; the ship related data comprises ship identification code, ship cargo type, and ship deadweight; the cargo related data comprises cargo type and cargo capacity;
constructing a shipping schedule related nine-intersection model based on the shipping route related data;
determining a consolidation plan for shipping data based on the shipping schedule related nine-intersection model, the cargo related data, and the ship related data, and carrying out consolidation based on the consolidation plan for transporting cargo from different origins;
the shipping schedule related nine-intersection model comprises nine-intersection model of route and nine-intersection model of time;
wherein determining a consolidation plan for shipping data based on the shipping schedule related nine-intersection model, the cargo related data, and the ship related data, and carrying out consolidation based on the consolidation plan comprises:
determining whether there is a consolidated shipping segment between the first route and the second route based on the nine-intersection model of route;
when there is a consolidated shipping segment, determining whether the consolidated shipping segment meets the time condition based on the nine-intersection model of time;
when the consolidated shipping segment meets a time condition, determining whether there are overlapping goods in the consolidated shipping segment based on the cargo related data;
when there are overlapping goods in the consolidated shipping segment, determining whether the consolidated shipping segment meets the requirements for cargo logistics loading based on ship related data;
when the consolidated shipping segment meets requirements for cargo logistics loading, carrying out consolidation in the consolidated shipping segment;
the nine-intersection model of route R₉ (SLᵢⱼ,SL_{pq}) is:
$$\{ \begin{matrix}{Port}_{ij 1} ⋂ {Port}_{pq 1} {Port}_{ij 1} ⋂ \partial {Port}_{pq} {Port}_{ij 1} ⋂ {Port}_{pqn} \\ \partial {Port}_{ij} ⋂ {Port}_{pq 1} \partial {Port}_{ij} ⋂ \partial {Port}_{pq} \partial {Port}_{ij} ⋂ {Port}_{pqn} \\ {Port}_{ijn} ⋂ {Port}_{pq 1} {Port}_{ijn} ⋂ \partial {Port}_{pq} {Port}_{ijn} ⋂ {Port}_{pqn}\end{matrix} \}$$
where, Portᵢⱼ₁ represents the departure port of route SLij, ∂Portᵢⱼ represents the intermediate stopping ports of route SLij, Portᵢⱼₙ represents the destination port of route SLij; Port_{pq1} represents the departure port of route SLpq, ∂Port_{pq} represents the stopping ports of route SLpq, Port_{pqn} represents the destination port of the SLpq route;
the nine-intersection model of time R₉ (Tᵢⱼ, T_{pq}) is:
$${R}_{9} ( {T}_{ij} , {T}_{pq} ) = \{ \begin{matrix}{T}_{ij 1} ⋂ {T}_{pq 1} {T}_{ij 1} ⋂ \partial {T}_{pq} {T}_{ij 1} ⋂ {T}_{pqn} \\ \partial {T}_{ij} ⋂ {T}_{pq 1} \partial {T}_{ij} ⋂ \partial {T}_{pq} \partial {T}_{ij} ⋂ {T}_{pqn} \\ {T}_{ijn} ⋂ {T}_{pq 1} {T}_{ijn} ⋂ \partial {T}_{pq} {T}_{ijn} ⋂ {T}_{pqn}\end{matrix} \}$$
where, Tᵢⱼ₁ represents the department time of the operating fleet of route SLij, ∂Tᵢⱼ represents the stopping time at each intermediate port of the operating fleet of route SLij, Tᵢⱼₙ represents the final port stop time of the operating fleet of route SLij; T_{pq1} represents the departure time of the operating fleet of route SLpq, and ∂T_{pq} represents the stopping time of the operating fleet of route SLpq at each intermediate port, T_{pqn} represents the final port stop time of the operating fleet on route SLpq.

2. The method for water transportation consolidation according to claim 1, the first route comprises a first departure port and a first destination port, and the second route comprises a second departure port and a second destination port;
the method that determining whether there is a consolidated shipping segment between the first route and the second route based on the nine-intersection model of route comprises:
based on the nine-intersection model of route, determining whether the first departure port and second departure port are the same, as well as whether the first destination port and second destination port are the same;
when the first department port and the second department port are the same, and the first destination port and the second destination port are also the same, there is a consolidated shipping segment between the first route and the second route.

3. The method for water transportation consolidation according to claim 1, the first route comprises the first departure port, the first destination port, and at least one first stopping port, the second route comprises the second departure port, the second destination port, and at least one second stopping port;
the method that determining whether there is a consolidated shipping segment between the first route and the second route based on the nine-intersection model of route also comprises:
determining whether the first departure port and second departure port are the same, and whether the first destination port and the second destination port are the same based on the nine-intersection model of route;
when the first departure port and the second departure port are the same, and the first destination port and the second destination port are the same, there is a consolidated shipping segment between the first route and the second route;
when the first departure port and the second departure port are the same, the first destination port and the second destination port are different, and at least one first stopping port is partially same as at least one second stopping port, there is a consolidated shipping segment between the first route and the second route;
when the first departure port and the second departure port are the same, the first destination port is different from the second destination port, and at least one first stopping port is completely different from at least one second stopping port, determining whether there is an intersection between the first destination port and at least one second stopping port, or whether there is an intersection between the second destination port and at least one first stopping port based on the nine-intersection model of route;
when there is an intersection between the first destination port and at least one second stopping port, or when there is an intersection between the second destination port and at least one first stopping port, there is a consolidated shipping segment between the first route and the second route;
when the first departure port and the second departure port are different, the first destination port is the same as the second destination port, and at least one first stopping port and at least one second stopping port are partially the same, there is a consolidated shipping segment between the first route and the second route;
when the first departure port and the second departure port are different, the first destination port is different from the second destination port, and at least two first stopping ports are partially the same as at least two second stopping ports, there is a consolidated shipping segment between the first route and the second route.

4. The method for water transportation consolidation according to claim 1, the consolidated shipping segment comprises a departure port for consolidated shipment and an arrival port for consolidated shipment;
the method that determining whether the consolidated shipping segment meets the time condition based on the nine-intersection model of time comprises:
obtaining the first departure time of the first route at the departure port for consolidated shipment and the first arrival time of the first route at the arrival port for consolidated shipment;
obtaining the second departure time of the second route at the departure port for consolidated shipment and the second arrival time of the second route at the arrival port for consolidated shipment;
based on the nine-intersection model of time, determining whether there is a time intersection between the first departure time and the second departure time, as well as whether there is a time intersection between the first arrival time and the second arrival time;
when there is a time intersection between the first departure time and the second departure time, and there is a time intersection between the first arrival time and the second arrival time, the consolidated shipping segment satisfies the time condition;
when there is no time intersection between the first departure time and the second departure time, and/or when there is no time intersection between the first arrival time and the second arrival time, determining whether the time difference between the first departure time and second departure time and the time difference between the first arrival time and the second arrival time are both less than a preset time difference;
when the time difference between the first departure time and the second departure time and the time difference between the first arrival time and the second arrival time are both less than the preset time difference, the consolidated shipping segment satisfies the time condition.

5. The method for water transportation consolidation according to claim 1,
the consolidated shipping segment comprises a first vessel in the first route and a second vessel in the second route;
the method that determining whether the consolidated shipping segment meets the requirements for cargo logistics loading based on ship related data comprises:
determining the cargo capacity of the first vessel, the ship deadweight of the first vessel, the cargo capacity of the second vessel, and the ship deadweight of the second vessel based on the ship related data;
determining whether the ship deadweight of the first vessel or the ship deadweight of the second vessel is greater than the sum of the cargo capacity of the first vessel and the cargo capacity of the second vessel;
when the ship deadweight of the first vessel or the ship deadweight of the second vessel is greater than the sum of the cargo capacity of the first vessel and the cargo capacity of the second vessel, the consolidated shipping segment meets the requirements for cargo logistics loading.

6. (canceled)

7. An equipment for water transportation consolidation, comprising a memory and a processor, wherein:
the memory configured to store one or more programs which, when executed by the processor, cause the processor to:
obtain shipping data from different shipping companies, classify the shipping data based on preset information categories and obtain shipping route related data, ship related data, and cargo related data; wherein the shipping route related data comprises shipping company code, route code, route departure port, route stopping ports, route destination port, departure time at departure port, arrival time at route stopping ports, and destination port arrival time; the ship related data comprises ship identification code, ship cargo type, and ship deadweight; the cargo related data comprises cargo type and cargo capacity;
construct a shipping schedule related nine-intersection model based on the shipping route related data;
determine a consolidation plan for shipping data based on the shipping schedule related nine-intersection model, the cargo related data, and the ship related data, and carry out consolidation based on the consolidation plan for transporting cargo from different origins;
the shipping schedule related nine-intersection model comprises nine-intersection model of route and nine-intersection model of time;
wherein the processor further:
determines whether there is a consolidated shipping segment between the first route and the second route based on the nine-intersection model of route;
when there is a consolidated shipping segment, determines whether the consolidated shipping segment meets the time condition based on the nine-intersection model of time;
when the consolidated shipping segment meets a time condition, determines whether there are overlapping goods in the consolidated shipping segment based on the cargo related data;
when there are overlapping goods in the consolidated shipping segment, determines whether the consolidated shipping segment meets the requirements for cargo logistics loading based on ship related data;
when the consolidated shipping segment meets requirements for cargo logistics loading, carries out consolidation in the consolidated shipping segment;
the nine-intersection model of route R₉ (SLᵢⱼ, SL_{pq}) is:
$$\{ \begin{matrix}{Port}_{ij 1} ⋂ {Port}_{pq 1} {Port}_{ij 1} ⋂ \partial {Port}_{pq} {Port}_{ij 1} ⋂ {Port}_{pqn} \\ \partial {Port}_{ij} ⋂ {Port}_{pq 1} \partial {Port}_{ij} ⋂ \partial {Port}_{pq} \partial {Port}_{ij} ⋂ {Port}_{pqn} \\ {Port}_{ijn} ⋂ {Port}_{pq 1} {Port}_{ijn} ⋂ \partial {Port}_{pq} {Port}_{ijn} ⋂ {Port}_{pqn}\end{matrix} \}$$
where, Portᵢⱼ₁ represents the departure port of route SLij, ∂Portᵢⱼ represents the intermediate stopping ports of route SLij, Portᵢⱼₙ represents the destination port of route SLij; Port_{pq1} represents the departure port of route SLpq, ∂Port_{pq} represents the stopping ports of route SLpq, Port_{pqn} represents the destination port of the SLpq route;
the nine-intersection model of time R₉ (Tᵢⱼ, T_{pq}) is:
$${R}_{9} ( {T}_{ij} , {T}_{pq} ) = \{ \begin{matrix}{T}_{ij 1} ⋂ {T}_{pq 1} {T}_{ij 1} ⋂ \partial {T}_{pq} {T}_{ij 1} ⋂ {T}_{pqn} \\ \partial {T}_{ij} ⋂ {T}_{pq 1} \partial {T}_{ij} ⋂ \partial {T}_{pq} \partial {T}_{ij} ⋂ {T}_{pqn} \\ {T}_{ijn} ⋂ {T}_{pq 1} {T}_{ijn} ⋂ \partial {T}_{pq} {T}_{ijn} ⋂ {T}_{pqn}\end{matrix} \}$$
where, Tᵢⱼ₁ represents the department time of the operating fleet of route SLij, ∂Tᵢⱼ represents the stopping time at each intermediate port of the operating fleet of route SLij, Tᵢⱼₙ represents the final port stop time of the operating fleet of route SLij; T_{pq1} represents the departure time of the operating fleet of route SLpq, and ∂T_{pq} represents the stopping time of the operating fleet of route SLpq at each intermediate port, T_{pqn} represents the final port stop time of the operating fleet on route SLpq.

8. A non-transitory computer-readable storage medium,
having stored thereon instructions that, when executed by a processor of a device, causes the processor to perform a method, the method comprising:
obtaining shipping data from different shipping companies, classifying the shipping data based on preset information categories, and obtaining shipping route related data, ship related data, and cargo related data; wherein the shipping route related data comprises shipping company code, route code, route departure port, route stopping ports, route destination port, departure time at departure port, arrival time at route stopping ports, and destination port arrival time; the ship related data comprises ship identification code, ship cargo type, and ship deadweight; the cargo related data comprises cargo type and cargo capacity;
constructing a shipping schedule related nine-intersection model based on the shipping route related data;
determining a consolidation plan for shipping data based on the shipping schedule related nine-intersection model, the cargo related data, and the ship related data, and carrying out consolidation based on the consolidation plan for transporting cargo from different origins;
the shipping schedule related nine-intersection model comprises nine-intersection model of route and nine-intersection model of time;
wherein determining a consolidation plan for shipping data based on the shipping schedule related nine-intersection model, the cargo related data, and the ship related data, and carrying out consolidation based on the consolidation plan comprises:
determining whether there is a consolidated shipping segment between the first route and the second route based on the nine-intersection model of route;
when there is a consolidated shipping segment, determining whether the consolidated shipping segment meets the time condition based on the nine-intersection model of time;
when the consolidated shipping segment meets a time condition, determining whether there are overlapping goods in the consolidated shipping segment based on the cargo related data;
when there are overlapping goods in the consolidated shipping segment, determining whether the consolidated shipping segment meets the requirements for cargo logistics loading based on ship related data;
when the consolidated shipping segment meets requirements for cargo logistics loading, carrying out consolidation in the consolidated shipping segment;
the nine-intersection model of route R₉ (SLᵢⱼ, SL_{pq}) is:
$$\{ \begin{matrix}{Port}_{ij 1} ⋂ {Port}_{pq 1} {Port}_{ij 1} ⋂ \partial {Port}_{pq} {Port}_{ij 1} ⋂ {Port}_{pqn} \\ \partial {Port}_{ij} ⋂ {Port}_{pq 1} \partial {Port}_{ij} ⋂ \partial {Port}_{pq} \partial {Port}_{ij} ⋂ {Port}_{pqn} \\ {Port}_{ijn} ⋂ {Port}_{pq 1} {Port}_{ijn} ⋂ \partial {Port}_{pq} {Port}_{ijn} ⋂ {Port}_{pqn}\end{matrix} \}$$
where, Portᵢⱼ₁ represents the departure port of route SLij, ∂Portᵢⱼ represents the intermediate stopping ports of route SLij, Portᵢⱼₙ represents the destination port of route SLij; Port_{pq1} represents the departure port of route SLpq, ∂Port_{pq} represents the stopping ports of route SLpq, Port_{pqn} represents the destination port of the SLpq route;
the nine-intersection model of time R₉ (Tᵢⱼ, T_{pq}) is:
$${R}_{9} ( {T}_{ij} , {T}_{pq} ) = \{ \begin{matrix}{T}_{ij 1} ⋂ {T}_{pq 1} {T}_{ij 1} ⋂ \partial {T}_{pq} {T}_{ij 1} ⋂ {T}_{pqn} \\ \partial {T}_{ij} ⋂ {T}_{pq 1} \partial {T}_{ij} ⋂ \partial {T}_{pq} \partial {T}_{ij} ⋂ {T}_{pqn} \\ {T}_{ijn} ⋂ {T}_{pq 1} {T}_{ijn} ⋂ \partial {T}_{pq} {T}_{ijn} ⋂ {T}_{pqn}\end{matrix} \}$$
where, Tᵢⱼ₁ represents the department time of the operating fleet of route SLij, ∂Tᵢⱼ represents the stopping time at each intermediate port of the operating fleet of route SLij, Tᵢⱼₙ represents the final port stop time of the operating fleet of route SLij; T_{pq1} represents the departure time of the operating fleet of route SLpq, and ∂T_{pq} represents the stopping time of the operating fleet of route SLpq at each intermediate port, T_{pqn} represents the final port stop time of the operating fleet on route SLpq.
